(19) United States
(12) Patent Application Publication
(10) Pub. No.: US 2011/0038546 A1
(43) Pub. Date: Feb. 17, 2011

(54) METHOD AND APPARATUS FOR DETECTING AN INSERTED SEGMENT INTO A VIDEO DATA STREAM

(75) Inventor: Gerrit Cornelis Langelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/599,100

(22) PCT Filed: May 5, 2008
(86) PCT No.: PCT/IB08/51717

§ 371 Date: Nov. 6, 2009

(30) Foreign Application Priority Data
May 8, 2007 (EP) 07107682.2

(51) Int. Cl. G06K 9/46

(52) U.S. Cl. 382/195; 382/190

(57) ABSTRACT

An inserted segment of a video data stream is detected if no graphical object is detected. The presence of at least one active graphical object in the video data stream is detected concurrently with detecting appearance of a new graphical object in the video data stream. The most reliable graphical object from the at least one active graphical object and the new graphical object is determined and the presence of the most reliable graphical object is detected from a point in the video data stream at the new graphical object was detected to appear. An inserted segment of the video data stream is detected if no graphical object is detected.

### FIELD OF THE INVENTION

The present invention relates to method and apparatus for detecting an inserted segment of a video data stream in which a graphical object is not present.

### BACKGROUND OF THE INVENTION

There are many existing systems for detecting the start and end of commercial blocks in TV broadcasts to allow the viewer to skip such commercials. One known technique for detecting commercials is detecting the presence a graphical object (for example, a logo) in a video data stream which only appears on the screen during a program.

In these systems, the four corners of each frame of the video data stream are monitored to detect the appearance of graphical objects. When a graphical object is detected, the presence of the graphical object is monitored in the video data stream. For example, if a logo is detected, the presence of the logo mask is monitored in the video data stream. The start of a commercial block is then detected when the graphical object is no longer present.

An example of such a method can be found in, “Detection of TV Commercials”, A. Albiol, M. J. Ch. Fullà, A. Albiol and L. Torres, Acoustics, Speech, and Signal Processing Proceedings, 2004, IEEE International Conference, 17-21 May 2004, pages 541-544. In this disclosure, a logo mask is extracted from the video data stream. Whenever the logo mask is detected, the system is said to be in a program state and whenever the logo mask is not detected, the system is said to be in a commercial state. If the current state changes to commercial, the system checks for a new logo mask. If a new logo mask is found, the system changes back to the program state.

Most of the existing systems for detecting graphical objects in a video data stream use a graphical object detector and a graphical object presence detector. The graphical object detector searches for static content (i.e. graphical objects) in the video data stream during a certain period. Once a cluster of, for example, static pixels or edges is found the graphical object presence detector is started. The graphical object presence detector begins at the start of the video data stream and checks every frame for the presence of the graphical object (i.e. the static content) found by the graphical object detector. If the graphical object is not present for a very long time (for example, if the graphical object changed shape or position) the graphical object detector is restarted. This may be, for example, somewhere in the middle of the video data stream. If the graphical object detector detects appearance of a new graphical object, the graphical object presence detector is restarted to check for the presence of the new graphical object etc.

In the existing approaches, random access to the video data stream is required. This is often a problem for embedded systems where data caching, timing and bus speeds are critical.

Furthermore, if a new graphical object is detected in the video data stream, the graphical object presence detector restarts from the beginning of the video data stream to detect the presence of the new graphical object. An unknown number of restarts are therefore required to complete the detection process. This means that the processing time to find all commercials cannot be determined in advance using the existing methods.

Moreover, if an invalid graphical object (such as a static letterbox edge) is found by the existing methods, there is no correction mechanism. Instead, the graphical object presence detector will continue to detect the letterbox boundaries until the end of the video data stream. This means that the graphical object detector will not be restarted to look for other graphical objects.

Existing graphical object presence detection techniques are mostly based on matching outlines of graphical objects with frame edges. However, this means that the existing techniques of presence detection fail in highly textured areas (for example, areas of leaves of a tree, grass etc). The existing techniques are not able to detect graphical objects in very bright areas, particularly in the case of transparent graphical objects.

### SUMMARY OF THE INVENTION

The present invention seeks to provide a system for detecting a graphical object in a video data stream, which overcomes one or more of the problems associated with existing methods. In particular, the present invention seeks to provide a streaming interface, which requires only a single run to find all graphical object free episodes (i.e. all commercials).

This is achieved, according to one aspect of the present invention, by a method for detecting an inserted segment of a video data stream in which a graphical object is not present, the method comprising the steps of: detecting presence of at least one active graphical object in a video data stream; concurrently detecting appearance of a new graphical object in the video data stream; determining the most reliable graphical object from the at least one active graphical object and the new graphical object; detecting presence of the most reliable graphical object from a point in the video data stream at which the new graphical object is detected; detecting an inserted segment of the video data stream if no graphical object is detected.

This is also achieved, according to a second aspect of the present invention, by apparatus for detecting an inserted segment of a video data stream in which a graphical object is not present, the apparatus comprising: a graphical object presence detector for detecting presence of at least one active graphical object; a graphical object detector in parallel to the graphical object presence detector for detecting appearance of a new graphical object; and a controller for determining the most reliable graphical object from the at least one active graphical and the new graphical object, wherein the graphical object presence detector detects presence of the most reliable graphical object from a point in the video data stream at which the new graphical object is detected and for detecting an inserted segment of the video data stream if no graphical object is detected.

In this way, new graphical objects are always detected and only the presence of the most reliable graphical object is detected. This ensures that there are no false detections due to transparent or moving graphical objects and that all detected graphical objects are true graphical objects (i.e. are not, for example, a static letterbox edge). The method of the present invention does not restart from the beginning of the video data stream, but detects the presence of the most reliable graphical object from the current position. In other words, the method of the present invention uses different graphical objects for different parts of the video data stream.

In an embodiment of the present invention, the step of concurrently detecting appearance of a new graphical object comprises the step of: determining whether the new graphical object is valid.

In this embodiment of the present invention, the step of determining whether the new graphical object is valid comprises the steps of: determining the number of times the new graphical object is detected in a period of time; outputting an indication that the new graphical object is valid if the number exceeds a threshold value; outputting an indication that the new graphical object is not valid if the number is below the threshold value.

Further, the step of outputting an indication that the new graphical object is not valid if the number is below the threshold value further comprises the steps of: discarding the new graphical object; continuing detecting presence of the at least one active graphical object.

In this way, new graphical objects are continually detected. Furthermore, the new graphical objects are verified so that invalid graphical objects can be corrected (i.e. discarded and replaced with a previous graphical object).

In one embodiment of the present invention, the step of concurrently detecting appearance of a new graphical object comprises the step of: concurrently detecting appearance of a new graphical object on the basis of a running average of colour space values, for example, luminance values.

In another embodiment of the present invention, the step of determining the most reliable graphical object from the at least one active graphical object and the new graphical object comprises the steps of: determining the performance of the at least one active graphical object; and detecting presence of the new graphical object if the determined performance of the at least one active graphical object is below a threshold value.

In this way, the reliability of the new graphical objects found is verified and only the most reliable graphical objects are detected. This means that graphical objects that are harder to find (i.e. those graphical objects in textured or bright areas) are not used over those that are more reliable. Furthermore, the presence of a graphical object is always detected, even in situations where detection is difficult. There is, therefore, never a gap when no graphical object can be detected since the presence of a graphical object in at least one of the regions can always be detected.

In another embodiment of the present invention, the video data stream comprises a plurality of frames and the step of concurrently detecting appearance of a new graphical object comprises the step of: monitoring each of the plurality of frames to detect appearance of a new graphical object.

According to this embodiment of the present invention, the step of monitoring each of the plurality of frames to detect appearance of a new graphical object comprises the steps of: dividing each frame into a plurality of regions; and monitoring each of the plurality of regions to detect appearance of at least one new graphical object in at least one of the plurality of regions.

In this way, it is possible to only monitor the regions that are most likely to contain graphical objects. For example, the four corners of the frame may be monitored. This means that less power and time is spent monitoring regions that are unlikely to contain graphical objects.

According to the same embodiment of the present invention, the step of determining the most reliable graphical object from the at least one active graphical object and the new graphical object comprises the steps of: determining a graphical object presence rate over a period of time in each of the plurality of regions in which appearance of a new graphical object is detected; determining the region having the highest graphical object presence rate; outputting an indication that the at least one new graphical object in the region having the highest graphical object presence rate is the most reliable graphical object; and discarding graphical objects in regions not having the highest graphical object presence rate.

In this way, only the presence of the most reliable graphical objects is detected.

The present invention only requires a single run in order for it to find all logo free episodes (i.e. all commercials). Furthermore, by continuously running a graphical object detector in parallel with the graphical object presence detector more information is available than in traditional detectors. This extra information improves the performance significantly. Continuously running a graphical object detector in parallel with the graphical object presence detector makes it possible to build a detector with a streaming interface and a pre-deterministic central processing unit (CPU) load.

### BRIEF DESCRIPTION OF THE DRAWINGS

For a more complete understanding of the invention, reference is made to the following description in conjunction with the accompanying drawings, in which:

FIG. 1 is a simplified schematic of apparatus according to an embodiment of the present invention;

FIG. 2 is a flowchart of a method for detecting a graphical object in a video data stream according to an embodiment of the present invention;

### DETAILED DESCRIPTION OF EMBODIMENTS OF THE INVENTION

With reference to Fig., the apparatus 100 of an embodiment of the invention comprises a pre-processor 102 for input of a video data stream from an input terminal 101. The pre-processor 102 is connected to a controller 104. The output of the controller 104 is connected to a graphical object presence detector 106. Data can be communicated from the controller 104 to the graphical object presence detector 106 and similarly, data can be communicated from the graphical object presence detector 106 to the controller 104. The output of the controller 104 is also connected to a graphical object detector 108. Data can be communicated from the controller 104 to the graphical object detector 108 and similarly, data can be communicated from the graphical object detector 108 to the controller 104. The controller 104 operates to collect data from the graphical object presence detector 106 and the graphical object detector 108.

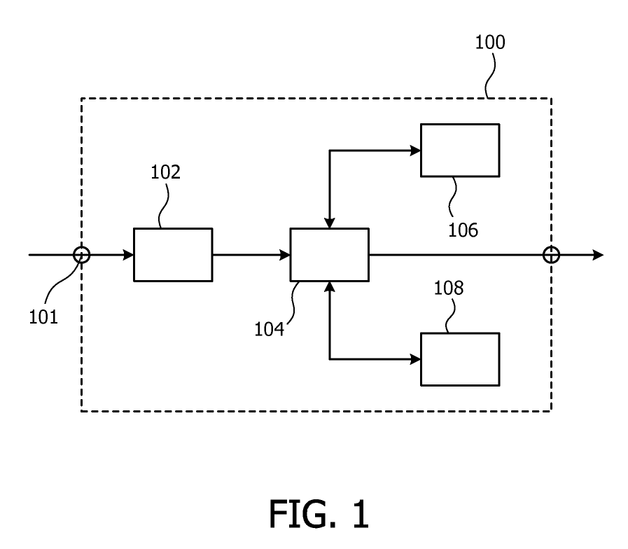

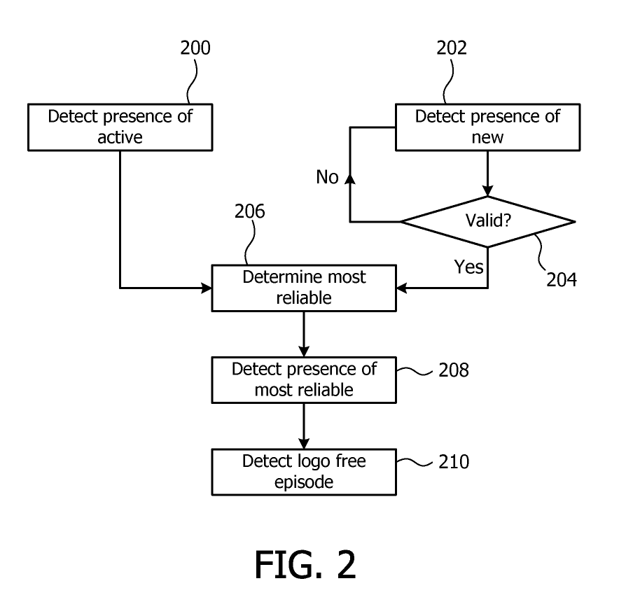

Operation of the apparatus 100 of FIG. 1 will now be described with reference to FIGS. 1 and 2.

A video data stream is input on the input terminal 101, and hence input into the pre-processor 102. The pre-processor 102 identifies a plurality of frames of the video data stream and then divides each identified frame into a plurality of regions. For each identified region, the pre-processor 102 determines the running average of luminance values.

The plurality of regions and the running average of luminance values of the regions are output from the pre-processor 102 and input into the controller 104. The running average of luminance values are then output from the controller 104 and input into the graphical object presence detector 106 and the graphical object detector 108.

The graphical object presence detector 106 detects the presence of an active graphical object in the video data stream, step 200.

At the same time, the graphical object detector 108 monitors each region to detect appearance of a new graphical object in the video data stream, step 202. The graphical object detector 108 detects appearance of new graphical objects on the basis of the running average of luminance values it received from the controller 104.

It is to be understood that the graphical object detector 108 can detect appearance of a new graphical object using any suitable technique and the running average of luminance values is used purely as an example for the purpose of a clear description. There are many techniques that exist for detecting the appearance of a new graphical object. In one technique, the graphical object detector 108 uses a histogram that has the same dimensions as a frame.

In this technique, the graphical object detector 108 resets the histogram and then checks each frame in turn (for example, one frame per second) to detect the appearance of a graphical object.

Firstly, the graphical object detector 108 detects edge pixels in the current frame using, for example, a Sobel operation and creates a threshold edge map of the frame. This results in a binary decision (i.e. edge, or no edge). The graphical object detector 108 increases the histogram on the positions where an edge is determined to be present.

The graphical object detector 108 checks the entries in the histogram to determine if there are entries that exceed a threshold value. If there are no entries that exceed the threshold value, the graphical object detector 108 checks the next frame for the presence of a new graphical object.

However, if there are entries that exceed the threshold value, a new graphical object may be present. In this case, the graphical object detector 108 finds the smallest bounding box around the histogram values that exceed the threshold value. The graphical object detector 108 then checks the dimensions of the smallest bounding box to determine whether they are valid. If the dimensions are determined to be valid, a new graphical object is present. The graphical object detector 108 then resets the histogram and checks the next frame for the presence of a new graphical object.

When the graphical object detector 108 detects a new graphical object, the new graphical object is input into the controller 104. The controller 104 then determines whether the new graphical object is valid, step 204. It is to be understood that during the process of the graphical object detector 108 detecting appearance of a new graphical object and the process of the controller 104 determining whether the new graphical object is valid, the graphical object presence detector 106 continues to detect the presence of the active graphical object.

In order to determine whether the new graphical object is valid, the controller 104 first determines the number of times the new graphical object is detected in a period of time. For example, the controller 104 may monitor the region where the new graphical object was found to determine the number of times the new graphical object is detected in the region in the period of time. If the number is below a threshold value, the controller 104 outputs an indication to the graphical object presence detector 106 and the graphical object detector 108 that the new graphical object is not valid. The new graphical object is then discarded. The graphical object presence detector 106 continues to detect the presence of the active graphical object (step 200) and the graphical object detector 108 continues to monitor the video data stream to detect new graphical objects (step 202).

If the number of times the new graphical object is detected exceeds a threshold value, the new graphical object is valid and the controller 104 determines the most reliable graphical object from the active graphical object and the new graphical object, step 206. In this way, the controller 104 can provide the graphical object presence detector 106 with the best graphical objects. The graphical object presence detector 106 can subsequently update and remove active graphical objects based on their reliability and thus detect presence of the most reliable graphical object, step 208. The presence of the most reliable graphical object is then detected from a point in the video data stream at which the new graphical object was detected to appear.

According to one embodiment of the present invention, in order to determine the most reliable graphical object, the controller 104 first determines the performance of the active graphical object using the history of the presence detections from the graphical object presence detector 106. The performance may, for example, relate to the number of positive detections of the active graphical object in the corresponding region, or the number of weak graphical object pixels of the active graphical object in the corresponding region.

If the performance is determined to be below a threshold value (for example, if there are an insufficient number of positive detections or there are too many weak graphical object pixels), the controller 104 replaces the active graphical object with the new graphical object and outputs an indication to the graphical object presence detector 106. The graphical object presence detector 106 then detects the presence of the new graphical object from a point in the video data stream at which the new graphical object was detected to appear.

If, on the other hand, the determined performance exceeds a threshold value (for example, if there are a sufficient number of positive detections or there are very few weak graphical object pixels), then the controller discards the new graphical objects and outputs an indication to the graphical object presence detector 106. The graphical object presence detector 106 then continues to detect the presence the active graphical object.

According to an alternative embodiment of the present invention, in order to determine the most reliable graphical object, the controller 104 determines a graphical object presence rate over a period of time in each of the plurality of regions in which appearance of the new graphical object is detected. The graphical object presence rate is determined using the history of the graphical object presence detections from the graphical object presence detector 106. The controller 104 then determines the region having the highest graphical object presence rate. The controller 104 outputs an indication to the graphical object presence detector 106 and the graphical object detector 108 that the new graphical object in the region having the highest graphical object presence rate is the most reliable graphical object. The graphical objects detected in regions not having the highest graphical object presence rate are discarded (i.e. are made inactive) and the graphical object presence detector 106 detects the most reliable new graphical object from a point in the video data stream at which the new graphical object was detected to appear.

The controller can check from time to time which region has the highest graphical object presence rate (using the history of the presence detections). In this way, the most reliable graphical object is the graphical object determined as having the highest graphical object presence rate. Any other graphical objects are discarded. Or alternatively, if the graphical object presence rate exceeds a certain threshold, the active masks for the other regions can be made inactive.

The controller 104 can then detect an inserted segment (for example, a commercial) of the video data stream, step 210. The controller 104 detects an inserted segment when no graphical object is detected. In other words, the controller 104 detects an inserted segment when the graphical object presence detector 106 no longer detects the presence of the active graphical object and the graphical object detector 108 does not detect any new graphical objects. The controller 104 then outputs an indication that an inserted segment is present on the output terminal of the apparatus 100.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for detecting an inserted segment of a video data stream in which a graphical object is not present, the method comprising the steps of:
detecting presence of at least one active graphical object in a video data stream;
concurrently detecting appearance of a new graphical object in said video data stream;
determining the most reliable graphical object from said at least one active graphical object and said new graphical object;
detecting presence of said most reliable graphical object from a point in said video data stream at which said new graphical object is detected; and
detecting an inserted segment of said video data stream if no graphical object is detected.

2. The method according to claim 1, wherein the step of concurrently detecting appearance of a new graphical object comprises the step of:
determining whether said new graphical object is valid.

3. The method according to claim 2, wherein the step of determining whether said new graphical object is valid comprises the steps of:
determining the number of times said new graphical object is detected in a period of time;
outputting an indication that said new graphical object is valid if said number exceeds a threshold value; and
outputting an indication that said new graphical object is not valid if said number is below said threshold value.

4. The method according to claim 3, wherein the step of outputting an indication that said new graphical object is not valid if said number is below said threshold value further comprises the steps of:
discarding said new graphical object; and
continuing detecting presence of said at least one active graphical object.

5. The method according to claim 1, wherein the step of concurrently detecting appearance of a new graphical object comprises the step of:
concurrently detecting appearance of a new graphical object on the basis of a running average of color space values.

6. The method according to claim 1, wherein the step of determining the most reliable graphical object from said at least one active graphical object and said new graphical object comprises the steps of:
determining the performance of said at least one active graphical object; and
detecting presence of said new graphical object if said determined performance of said at least one active graphical object is below a threshold value.

7. The method according to claim 1, wherein said video data stream comprises a plurality of frames and the step of concurrently detecting appearance of a new graphical object comprises the step of:
monitoring each of said plurality of frames to detect appearance of a new graphical object.

8. The method according to claim 7, wherein the step of monitoring each of said plurality of frames to detect appearance of a new graphical object comprises the steps of:
dividing each frame into a plurality of regions; and
monitoring each of said plurality of regions to detect appearance of at least one new graphical object in at least one of said plurality of regions.

9. The method according to claim 8, wherein the step of determining the most reliable graphical object from said at least one active graphical object and said new graphical object comprises the steps of:
determining a graphical object presence rate over a period of time in each of said plurality of regions in which appearance of a new graphical object is detected;
determining the region having the highest graphical object presence rate;
outputting an indication that said at least one new graphical object in said region having the highest graphical object presence rate is the most reliable graphical object; and
discarding graphical objects in regions not having the highest graphical object presence rate.

10. A computer program product comprising a plurality of program code portions for carrying out the method according to claim 1.

11. Apparatus for detecting an inserted segment of a video data stream in which a graphical object is not present, the apparatus comprising:
a graphical object presence detector for detecting presence of at least one active graphical object;
a graphical object detector in parallel to said graphical object presence detector for detecting appearance of a new graphical object; and
a controller for determining the most reliable graphical object from said at least one active graphical and said new graphical object, wherein said graphical object presence detector detects presence of said most reliable graphical object from a point in said video data stream at which said new graphical object is detected and for detecting an inserted segment of said video data stream if no graphical object is detected.

12. Apparatus according to claim 11, wherein the apparatus further comprises a pre-processor for identifying a plurality of frames of said video data stream, wherein said graphical object detector monitors each of said plurality of frames to detect appearance of a new graphical object.
